(19) United States
(12) Patent Application Publication
(10) Pub. No.: US 2010/0025463 A1
(43) Pub. Date: Feb. 4, 2010

(54) Digital transmission system (DTS) for bank automated teller machines (ATM) security

(76) Inventor: Behruz Nader Daroga, Brampton (CA)

Correspondence Address: FAY SHARPE LLP, 1228 Euclid Avenue, 5th Floor, The Halle Building, Cleveland, OH, 44115, US

(21) Appl. No.: 12/446,798

(22) PCT Filed: Oct. 23, 2006
(86) PCT No.: PCT/CA06/01722

§ 371 Date: Apr. 23, 2009

(51) Int. Cl. G06K 5/00; G06K 19/00

(52) U.S. Cl. 235/382; 235/492; 235/379

(57) ABSTRACT

This invention describes a hand held digital transceiver to transmit a signal as light (visible and invisible) or sound (audible and inaudible) or other digitized code for alphanumeric in any language, special characters or symbols or graphic or pictures or any combination thereof, to the ATM that is equipped with a compatible digital transceiver card. This card can transmit and receive the said signals and codes using a driver and/or firmware for the operation, management and maintenance of this security system. Upon verification, of the transmitted code, by the ATM, access is granted. The ATM then transmits a randomly selected new code of any combination of the codes or signals stated above to the transceiver for storage in the said transceiver and recording on the client card. The said transmission from the ATM cannot be stored in any other hand held transceiver located within range of the transmission.

This invention relates to an ATM security system utilizing a digital transmission that is changed after each use of the system.

Conventional security systems for ATMs utilize the provision of a client card and an access code or Personal Identification Number (PIN). The user inserts the client card in the designated place in the ATM enabling it to read the client information including the PIN. The user is prompted for the PIN. Upon entering the correct PIN, access is granted. However, such systems have been compromised, notably by the use of a hidden device attached to the ATM to record the information on the card. A hidden camera records the PIN entered. A new card is then produced to gain unauthorized access to accounts at banks, and other financial institutions, with considerable loss of monetary funds. Client cards can also be stolen once the PIN is captured by a hidden camera. Clearly a need is identified for a “hacker proof” security system for use in ATMs at banks and other financial institutions.

The drawbacks of the present security system when accessing bank accounts from ATMs are eliminated with the use of a hand held digital transceiver and a compatible ‘card’ inserted in the ATM. Any existing ATM can be equipped to use the DTS for security with the use of a compatible card. The hand held transceiver used for accessing ATMs is capable of transmitting (and receiving and storing) a signal or code which can be light (visible and invisible) or sound (audible and inaudible) or other digitized code for alphanumeric in any language, special characters or symbols or graphic or pictures or any combination thereof. The source of sound can be ATM generated by the said “card” or pre-recorded from a vast array of sources. These sources are listed in, but not limited to, the list in appendix 1. The list of pictures can be similarly taken from, but not limited to the said appendix. Variables for alphanumeric in any language, special characters, symbols, light, or graphics are equally vast.

When a client is first issued with a client card, at a bank branch, the person is also issued with the hand held transceiver. This is preset with a default code. The client inserts the card in a computer system equipped with the DTS security system with the same default code. The computer system then generates a random code of the signals stated above. This is recorded on the client card and the bank's security servers as well as the hand held transceiver. Existing clients are invited to visit their local branch for the new client card. However, the old client cards can still be used in the ATMs as before.

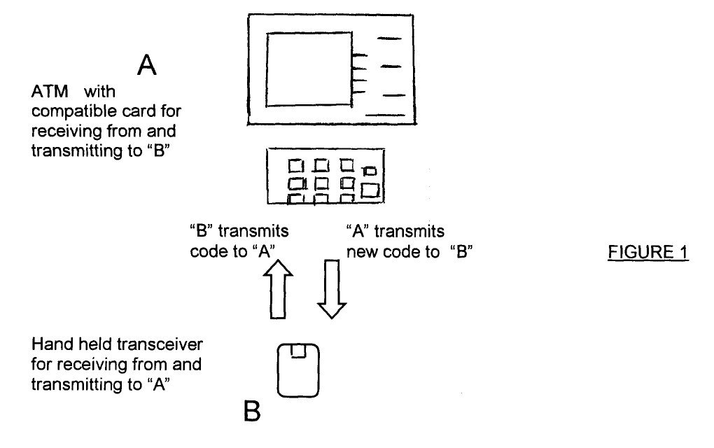

FIG. 1 illustrates the use of the system. The client inserts the client card in the ATM (“A”) as always. When prompted for a PIN, the client presses a button on the hand held transceiver (“B”) which transmits the code recorded at the bank branch when the card was first issued. On verification by the ATM of the code, access to the ATM is granted and a new randomly selected code is transmitted from “A” to “B”. This new code is stored in “B” as well as recorded on the client card and the bank's security servers. The new code is randomly selected by the transceiver card in the ATM and can be any one of the light (visible or invisible), sound (audible or inaudible) alphanumeric in any language, symbols, special characters, graphics or pictures. These variables are pre-recorded and saved on the ATM transceiver card. On exiting the ATM, and re-use of the ATM, the new code is transmitted by “B” to “A” and verified by the ATM, which generates and transmits a new randomly selected code (for storage in “B”) and grants access.

This process continues for each use of the system. Therefore “PINs” are changed on each use and do not need to be remembered. The codes would be impossible to hack. Recording the transmitted signal would serve no purpose as this signal is changed on each use. Recording the information on the card would serve no purpose as the “PIN” is changed on each use. The new code transmitted by “A” cannot be received and stored in any other hand held transceiver located within range of the signal, since the system will only respond to a specified transceiver. Gaining unauthorized possession of the card would serve no purpose without the hand held transceiver. Needless to say, the transceiver has to be located in a secure place and separate from the client card.

In the event, the hand held transceiver and/or client card is lost or stolen, the user phones the bank to invalidate them. The user no doubt will need to answer a few security questions before the client card is invalidated. The user then visits the bank branch for a new transceiver and/or client card.

### APPENDIX 1

Sources and agents of sound and pictures include but not limited to:
1. Human beings and animals, birds, insects, fish, whales, dolphins.
2. In any language, music, songs, videos, themes music from films. Musical instruments and tuning forks.
3. Running water, rain water, waterfalls, and tributaries, rivers lakes, melting snow and ice, piped water, treated and untreated water, icebergs, glaciers.
4. Volcanoes, hurricanes, tornadoes, gales, ordinary wind, solar wind, earthquakes, tsunami, lightning and thunder or any other sounds from nature.
5. Operating machines of any size, anywhere in any industry including ultrasound.
6. Transport vehicles of any size, powered or manual, used anywhere.
7. Objects falling to earth from sky.
8. Explosions, avalanches.
9. Elevators.
10. Sporting events and stadiums, race courses.
11. Church or religious services conducted anywhere in any religion.
12. Clock tower bells, church bells in any religion anywhere, door bells and chimes.
13. Public meetings and demonstrations.
14. Theme park, funfair and circus sounds.
15. Farms and markets.

1-21. (canceled)

22. A system for providing access authorization to an automated teller machine (ATM), comprising:
a security device for transmitting a current signal upon user command once only along a communications interface to the ATM and for receiving a subsequent signal along the communications interface from the ATM;
a client card for insertion into the ATM and for maintaining thereon a stored signal to be read by the ATM until updated by the ATM with another signal; and
security means associated with the ATM for:
a. reading the stored signal on the client card upon insertion into the ATM;
b. receiving the current signal from the security device along the communications interface; and
c. authorizing a user-access to the ATM if the current signal corresponds to the stored signal; and
if user-access is authorized:
d. generating a second signal for authorizing a subsequent user-access to the ATM;
e. updating the client card with the second signal; and
f. transmitting the second signal to the security device.

23. The system according to claim 1, wherein the security means thereafter precludes user-access to the ATM upon withdrawal of the client card.

24. The system according to claim 1, wherein the security device comprises means for storing the subsequent signal received along the communications interface until it is transmitted along the communications interface as the current signal corresponding to the subsequent user-access to the ATM.

25. The system according to claim 1, wherein the security device and client card are preconfigured before initial use with a default signal as the first signal.

26. The system according to claim 1, wherein the communications interface is restricted to communications between the security device and the security means.

27. The system according to claim 1, wherein the signals passing along the communications interface are based on technology selected from a group consisting of: visible light, invisible light, audible sound, inaudible sound, digitized codes for alphanumeric characters in a language, digitized codes for special characters, digitized codes for symbols, digitized codes for graphics, digitized codes for pictures and a combination of one or more of the members of the group.

28. The system according to claim 1, wherein the signals passing along the communications interface are recorded from a source selected from a group consisting of: computer-generated material; human beings, animals, birds, insects, fish, whales, dolphins; music, songs, videos, theme music from films, musical instruments, tuning forks, running water, rain water, waterfalls, tributaries, rivers, lakes, melting snow, melting ice, piped water, treated water, untreated water, icebergs, glaciers, volcanoes, hurricanes, tornadoes, gales, ordinary wind, solar wind, earthquakes, tsunami, lightning, thunder, sounds from nature, operating machines of any size anywhere in any industry, ultrasound, transport vehicles of any size, powered or manual, used anywhere, objects falling to earth from sky, explosions, avalanches, elevators, sporting events, stadiums, race courses, church or religious services conducted anywhere in any religion, clock tower bells, church bells in any religion anywhere, door bells, chimes, public meetings, demonstrations, theme parks, funfair, circus sounds, farms and markets.

29. The system according to claim 1, wherein the first signal and/or the second signal is randomly selected.

30. The system according to claim 1, wherein the first signal and/or the second signal is chosen from a library of pre-recorded signals accessible by the security means.

31. The system according to claim 8, wherein the library of pre-recorded signals comprise pre-recorded signals.

32. The system according to claim 1, wherein the security means comprises a card installed within a computer in the ATM.

33. The system according to claim 1, wherein the first signal and/or the second signal is digitized.

34. The system according to claim 1, wherein the client card includes a magnetic tape strip or embedded microchip for maintaining the stored signal.

35. The system according to claim 1, wherein the security device is a handheld device.

36. The system according to claim 1, wherein the client card is linked to a specified security device.

37. The system according to claim 15, wherein the ATM will only accept the current signal from the specified security device.

38. A method of providing access authorization to an automated teller machine (ATM), comprising the acts of:
a. restricting by a security means associated with the ATM, user-access to the ATM until:
i. a client card corresponding to an account is inserted into the ATM, the client card maintaining thereon a stored signal until updated with another signal, the stored signal to be read from the client card;
ii. a current signal is received by the security means from a security device along a communications interface between the security device and the security means; and
iii. the security means verifies that the current signal corresponds to the stored signal and authorizes user-access to the ATM; and
b. upon authorizing user-access to the ATM, the security means:
i. generating a second signal for authorizing a subsequent user-access to the ATM;
ii. updating the client card with the second signal; and
iii. transmitting the second signal to the security device along the communications interface for retransmission as the current signal for the subsequent user-access to the ATM.

39. A security means associated with an automated teller machine (ATM) for:
precluding user access to the ATM until:
a stored signal is read from a client card corresponding to a user account inserted into the ATM, the client card maintaining thereon the stored signal until updated with another signal;
a current signal is received by the security means along a communications interface from a security device adapted to transmit the current signal once only along the communications interface and thereafter receive a subsequent signal along the communications interface from the security means; and
the security means verifies that the current signal corresponds to the stored signal and authorizes user-access to the ATM; and
upon authorizing user-access to the ATM, the security means:
generating a second signal for authorizing a subsequent user-access to the ATM;
updating the client card with the second signal; and
transmitting the second signal along the communications interface.

40. A security device for providing access authorization to an automated teller machine (ATM), the security device adapted to transmit, upon command, a current signal once only along a communications interface and thereafter to receive a subsequent signal along the communications interface and whereby security
means associated with the ATM may:
preclude user-access to the ATM until:
a client card corresponding to an account is inserted into the ATM, the client card maintaining thereon a stored signal to be read by the ATM until updated with another signal;
the current signal is received from the security device along the communications interface; and
the security means verifies that the current signal corresponds to the stored signal and authorizes user-access to the ATM; and
upon authorizing user access to the ATM:
generate a second signal for authorizing a subsequent user-access to the ATM;
update the client card with the second signal; and
transmit the second signal along the communications interface to the security.

41. A client card corresponding to a user account for providing access authorization for an automated teller machine (ATM), the client card adapted to maintain a stored signal to be read by the ATM until updated with another signal, whereby security means associated with the ATM may:
preclude user-access to the ATM until:
the client card is inserted into the ATM and the stored signal is read by the ATM;
a current signal is received by the security means along a communications interface from a security device adapted to transmit the current signal once only along the communications interface and thereafter receive a subsequent signal along the communications interface from the security device; and
the security means verifies that the current signal corresponds to the stored signal and authorizes user access to the ATM; and
upon authorizing user-access to the ATM,
generate a second signal for authorizing a subsequent user access to the ATM;
update the client card with the second signal; and
transmit the second signal along the communications interface.
